(19) United States
(12) Patent Application Publication
(10) Pub. No.: US 2009/0064200 A1
(43) Pub. Date: Mar. 5, 2009

(54) Centralized Enhancement Service

(76) Inventor: Wolfgang Walter, Hambrucken (DE)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/848,090

(22) Filed: Aug. 30, 2007

(51) Int. Cl. G06F 3/00

(52) U.S. Cl. 719/328

(57) ABSTRACT

A supply chain management program to enable a customer to create new screens or modified screens in the supply chain management interface. The system includes a centralized enhancement mechanism allowing the supply chain management to detect enhancements to screens and the associated transactions. The customer implements a screen enhancement interface and a template for each screen enhancement. Upon activation of a transaction the system and method automatically detect the enhancements and generate the enhanced screen. The method and system also provide processes for updating the screens and database through the enhanced screen.

### BACKGROUND

1. Field of the Invention

The embodiments of the invention relate to software customization. Specifically, the embodiments are related to a method and system for providing enhanced user interface displays in supply chain management software.

2. Background

Supply chain management software provides a set of interfaces that allow end users to view and modify supply chain management data. These user interfaces provide access to the data maintained by the software through individual windows or ‘screens.’ These screens present the data as a fixed form or table format. The table format for each screen is designed by the supply chain management software provider. Each screen has a fixed relationship with a back end component that provides the data to the screen. The back end component also receives data from the screen and updates that data in storage. The back end component is referred to as a transaction or transaction module.

Modification of a form or table layout of a screen must be undertaken by the software provider or a skilled programmer familiar with the software. The changes to the form or table layout must be done in a piece-meal fashion with separate transactions coded, forms modified and the software modified to accommodate the new transactions and forms. Each new transaction or change to the screen is implemented separately and each requires a modification of the software program itself. Modification of the software program by customers (e.g., end users of the software) to accommodate customizations makes providing customer service difficult and decreases the reliability of the software. Modification by the software provider is often not cost effective for a single or small client.

### SUMMARY

Embodiments of the invention include a method and system for enabling a customer to create new screens or modified screens in a supply chain management interface. The system includes a centralized enhancement mechanism allowing the supply chain management software to detect enhancements to screens and the associated transactions without being modified by the customer. The customer implements a transaction enhancement, interface and a template for each screen enhancement. Upon activation of a transaction the system and method automatically detect the enhancements and generate the enhanced screen. The method and system also provide processes for updating the screens and database through the enhanced screen.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1A is a diagram of one embodiment of a screen of a supply chain management software application.

FIG. 1B is a diagram of one embodiment of an enhanced screen of a supply chain management software application.

FIG. 2 is a diagram of one embodiment of a centralized enhancement system.

FIG. 3A is a diagram of one embodiment of a centralized enhancement system implementation.

FIG. 3B is a diagram of one embodiment of a centralized enhancement system initialization.

FIG. 4 is a flowchart of one embodiment of a process for initializing enhancement services.

FIG. 5 is a diagram of one embodiment of centralized enhancement transaction interaction management.

FIG. 6 is a flowchart of one embodiment of process for transaction interaction processing.

### DETAILED DESCRIPTION

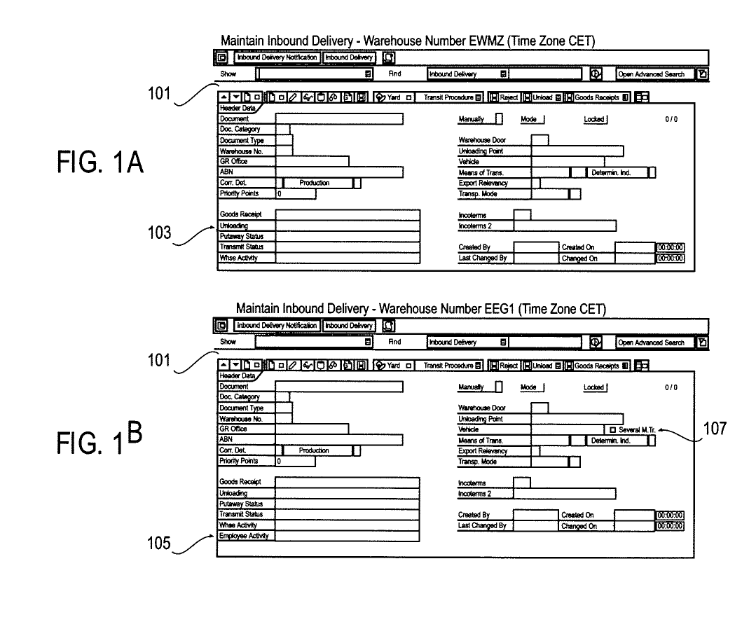

FIG. 1A is a diagram of one embodiment of a screen of a supply chain management software application or system. The supply chain management (SCM) software or system may provide any number of screens and similar interfaces that allow a customer to manage supply chain related activities. In one embodiment, the centralized enhancement system is part of an SCM system or software or part of an associated system. The SCM system may be a software platform or application that provides enterprise level supply chain management functionality including product, transportation and warehouse management as well as similar functionality. One skilled in the art would understand that the centralized enhancement system is applicable to other software applications and platforms such as database management interfaces, other enterprise resource planning (ERP) systems, centralized resource management (CRM) systems and similar software and platforms. For sake of clarity, an example embodiment of centralized enhancement services is provided in the context of SCM software and an SCM system. One skilled in the art would understand that the principles and features described herein in relation to the SCM software embodiment would be applicable to other systems and software.

In the illustrated example, a ‘Maintain Inbound Delivery’ screen 101 is one screen supported by SCM system. The screen 101 may be tied to a transaction that services the screen by retrieving data to populate the fields 103 of the screen 101 and to update a database or similar storage system in response to modification of the fields 103 of the screen 101. The screen 101 can have any number of fields 103 and can be serviced by any number of transactions. When the screen 101 is selected for display all the associated transactions required to service the screen 101 are initialized.

FIG. 1B is a diagram of one embodiment of an enhanced screen of a supply chain management system or application. In one example, the screen 101 can be enhanced by the addition of new fields 105, 107. The new fields 105, 107 can represent any data or values desired by the customer. The new fields 105, 107 may be indistinguishable from other fields of the screen 101 to a user. Any type or number of fields 105, 107 can be added or used to enhance the screen 101. In one embodiment, the fields 105, 107 can have any position within the screen 101. In another embodiment, the added fields are in a discrete or limited area or section of the screen 101. Adding fields to a limited area allows them to be identified easily and simplifies the implementation of the enhanced screen.

Each of the added fields 105, 107 may be associated with a transaction module or other program that can service the screen 101 during an initialization process and in response to modifications or refresh requests of the screen 101. The enhanced fields may be entirely new fields 105 or modifiers or attributes 107 associated with other fields. The source of the data for these fields may be a database, a software program or similar source. Also, the data may be derived from other data in the screen 101 or available through transactions associated with the screen.

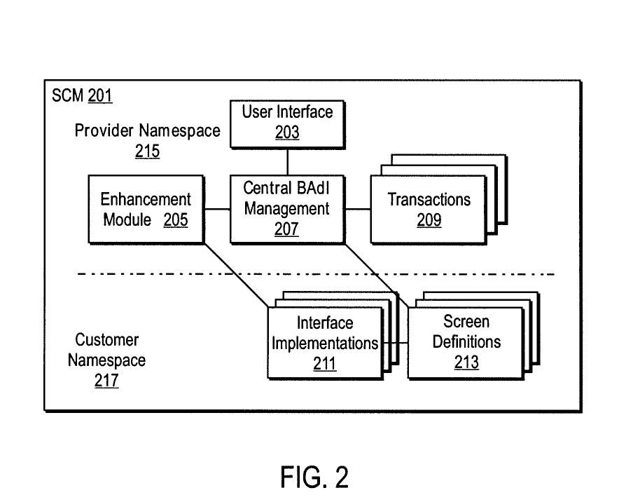

FIG. 2 is a diagram of one embodiment of a centralized enhancement system. An SCM system 201 includes a provider namespace 215 and a customer namespace 217. The provider namespace 215 encompasses the components of the SCM system 201 that the system provider has designed, defined or programmed. The customer namespace 217 encompasses components of the SCM system 201 that the customer of the provider, user or administrator of the SCM system 201 has defined. The SCM system 201 is thereby designed to enable customization by supporting the customer namespace 217 within the SCM system 201. The SCM system 201 includes a user interface 203, enhancement module 205, central BAdI management module 207, transaction modules 209, interface implementation modules 211, screen definitions 213 and similar components. In one embodiment, the SCM system 201 may also include enhanced transaction modules or other programs that service the enhancements of the SCM system 201.

A user interface 203 is a software component or set of software components that provide a user interface 203 such as a graphical user interface (GUI) to a user of the SCM system 201. The user interface 203 allows a user to interact with and utilize the functionality of the SCM system 201 including the centralized enhancement services. As used herein, a ‘set’ refers to any positive whole number of items including one item. The user interface 203 may provide any number of user interface mechanisms (e.g., menus, buttons and similar input mechanisms) and screens to enable the viewing and modification of the data managed by the SCM system 201. A user may utilize the centralized enhancement system by selecting transaction or opening a screen that relies on the enhancement services.

Enhancement services may be defined or linked to the SCM system 201 through a centralized enhancement module 205. The centralized enhancement module 205 defines an interface for implementation of the enhancement services. The SCM system 201 can access the enhancement module to determine whether an enhanced service exists for any transaction. The enhancement module 205 may also include a method associated with an enhancement, a business ad-in (BAdI) definition or similar data allowing the SCM system 201 to associate enhanced services with each transaction and/or screen. The enhancement module 205 stores the enhancement data for all transactions in the SCM system 201 thereby providing a centralized location for determining the availability of such enhancements.

Central BAdI management 207 is centralized management module that is responsible for the management of the interaction and communication between transactions and screens in the SCM system 201. The central BAdI management 207 defines an interface and provides methods or functions that are called by interface implementations. The method and functions defined by the central BAdI management include process before output (PBO) and process after input (PAI) methods that provide functionality to the enhanced screens by associating the enhancements with transactions or similar programs. The central BAdI management 207 determines a transaction or similar program to service each PBO and PAI method invocation. The central BAdI management 207 passes parameters to the appropriate transactions or programs that are received from or based on the PBO or PAI and forwards the data returned by the transactions or similar programs to the screen or updates the screen that invoked the method based on the returned data.

The SCM system 201 can include any number of transactions 209. Transactions 209 represent the functionality of the SCM system 201. For example, a transaction may represent maintaining an inbound delivery. The transaction handles the retrieval of data associated with its function as well as the modification or calculations related to such data. The transaction services can be modified by enhancements embodied in interface implementations of interface defined in the enhancement module 205.

The interface implementations 211 are customer defined and reside in customer namespace 217. The interface implementations 205 supplement and utilize the transactions 209 to provide customized functionality to a customer. For example, when utilizing the transaction for maintaining an inbound delivery, a customer may desire to view or modify delivery header data. However, the transaction does not provide this data. The customer can enhance the transaction by implementing or modifying a screen definition 213 that defines the form or table layout of a screen as well as user interface functionality to display, in this example, the delivery header data. The customer also implements an interface implementation 211 that corresponds to the customer defined screen 213 and the transaction 209. The interface implementation 211 may specify a different transaction or program that is provides the requisite data for the enhancement.

The screen definitions 213 may be templates and may have any format including an extensible mark-up language (XML) format or similar format. The screen definitions 213 may be partially provider defined or modifications of a standard screens that are modified to allow for the new functionality or data to be displayed through the screen. The customer can modify or generate the screen definitions to add new fields, text, check boxes, menus or similar user interface and screen elements.

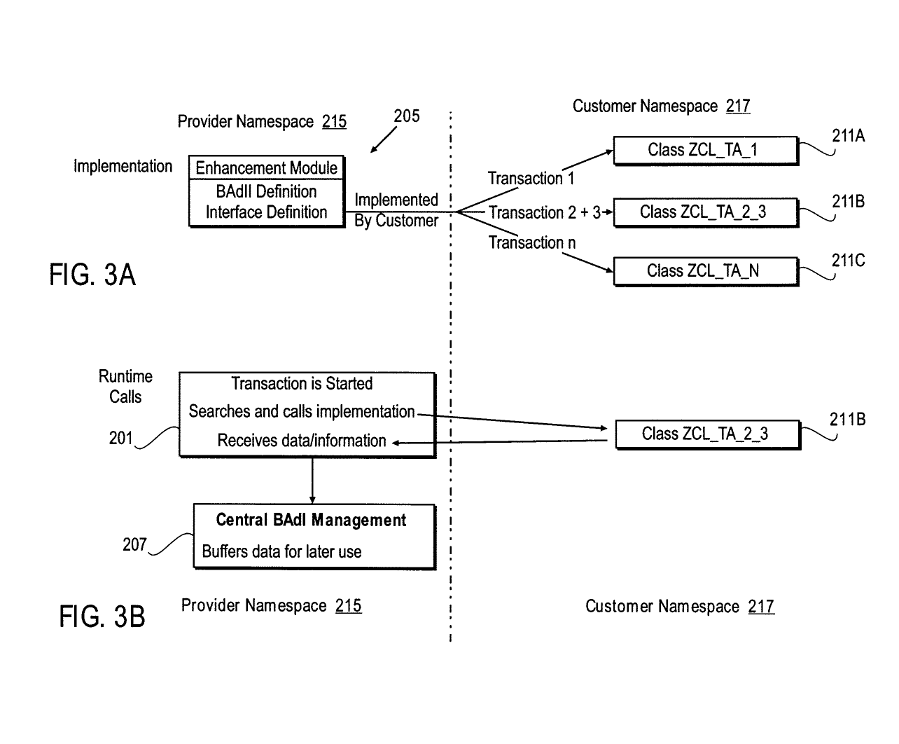

FIG. 3A is a diagram of one embodiment of a centralized enhancement system implementation. The implementation demonstrates the relationship between the enhancement module 205 and interface implementations 211A-C. The enhancement module 205 is created by the provider and resides in the provider namespace 215 of the SCM system. The interface implementations 211A-C are created by a customer and reside in the customer namespace 217. Each interface implementation 211A-C can be tied to a separate transaction or set of transactions. Any number of interface implementations (1 . . . n) can be created and utilized by a customer.

In one embodiment, the enhancement module defines an abstract class or interface that is implemented by the customer as a set of classes in the customer namespace 217. The implementation may utilize object-orient programming paradigms such as polymorphism to simplify the task of implementing enhancements without requiring significant modification of the code of the SCM system. For example, the enhancement system may be implemented using JAVA® developed by Sun Microsystems of Santa Clara, Calif., C++ or a similar programming language or platform.

FIG. 3B is a diagram of one embodiment of a centralized enhancement system initialization. The diagram shows the interrelationships between the components that are utilized to initialize a transaction and the interface implementations that are associated with a transaction. A transaction is initialized in response to a selection or opening of a transaction or screen corresponding to a transaction. The selection or opening may be affected from a user interface or similar initialization module 301 of the software system. The initialization module 301 may be a separate module responsible for initializing transactions or may be a sub-component of another module or component of the SCM system. The initialization module 301 searches for and calls each interface implementation associated with an initialized transaction. The interface implementations may be searched in the customer namespace or located through the enhancement module or similarly searched or located.

The interface implementation corresponding to the initializing transaction is called and the transaction identifier for each interface implementation and any related information is passed to the interface implementation by the initialization module 301. For example, location information and transaction type may be provided to each interface implementation to properly associate the initializing transaction with the enhancement services and screen. Different locations, e.g., warehouses, may utilize different enhancements dependent on the services and facilities available at that warehouse. Passing the location information accommodates different enhancements utilized at different locations.

The interface implementation 211B returns the implementation information necessary to provide enhanced services including a screen identifier and data source identifier to the initialization module 301. The screen identifier identifies a screen definition or similar data that defines the modification to a screen to display transaction data to accommodate the enhancement to the transaction. The data source identifier provides identification for the source of enhancement data. The data source may be a database location, a transaction, a program external to the SCM system, another SCM module or component or a similar data source.

The initialization module 301 utilizes the returned data to complete the initialization of the transaction along with the enhancement. The initialization module 301 generates the enhanced screen and accesses the data source to obtain enhanced data to populate the screen enhancements. Similarly, the initialization module 301 access the transactions that populate the remainder of a screen that is generated. The initialization module 301 then passes the transaction related data such as the transaction identification information, enhancement identification information, data source information, screen identification information and similar information on to the central BAdI management 207.

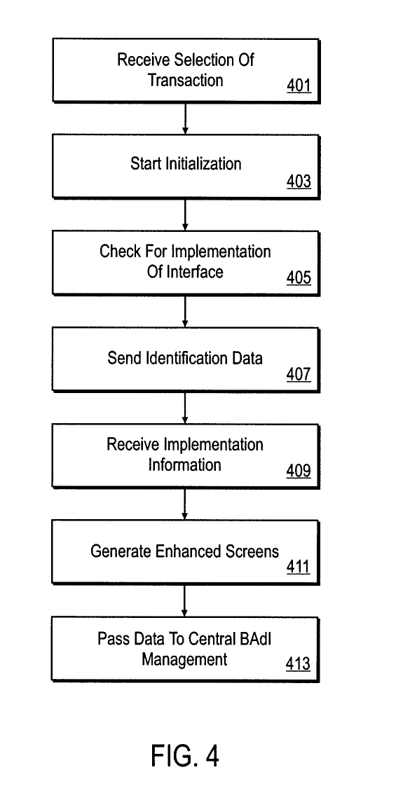

FIG. 4 is a flowchart of one embodiment of a process for initializing enhancement services. The flowchart details the initialization process that is implemented by the components described above in relation to FIG. 3. The process is started in response to a selection of a transaction or associated screen by a user (block 401). The user may select a transaction through a user interface or similar mechanism within the SCM system. The transaction initialization may then be managed by a specialized transaction initialization module or may be handled by other SCM system components (block 403).

The initialization module searches for enhancements associated with the selected transaction (block 405). The initialization module may search through the customer namespace for interface implementations that correspond to the transaction or may access the enhancement module, which may have methods to provide or to access the appropriate interface implementation or links to the appropriate interface implementations for a selected transaction or screen. If no interface implementation is found for the transaction then the transaction continues to initialize normally. If an interface implementation is found for the transaction, then the interface implementation class is instantiated to handle the enhanced services.

The initialization module calls a method of the interface implementation or similarly passes identification data to the interface implementation (block 407). An example of an interface implementation is provided in TABLE I.

TABLE I
BAdI Interface definition: CUSTOMER-EXAMPLE
BAdI-interface to be implemented by the customer

| Parameter | Type | Description |
|---|---|---|
| METHOD: | | |
| INITILAIZE | | |
| I_Transaction | CHAR3 | Identifier for Transactions |
| I_Enhancement | CHAR3 | Identifier for enhancement |
| I_Additional | ANY | Additional data |
| E_Program | CHAR40 | Program containing the screen |
| E_Screen | CHAR4 | Screen number |
| ATTRIBUTES | | |
| C_Transaction_1 | CHAR3 | Identifier for Transaction |
| C_Transaction_2 | CHAR3 | Identifier for Transaction 2 |
| C_Enhancement_A | CHAR3 | Enhancement A |
| C_Enhancement_A | CHAR3 | Enhancement B |
| C_Origin_PAI | CHAR1 | Identifier for PAI call |
| C_Origin_PBO | CHAR1 | Identifier for PBO call |
| T_Buffer | TABLE | Buffer table for input data of |
| | | method INITIALIZE |

The initialization module then receives return data from the interface implementation (block 409). The returned information includes a screen identifier and data source identifier. This data is utilized to generate the identified screen, retrieve the data related to the transaction and the enhancement from the transaction and the data source (block 411). The data source can be any program or data storage location including another transaction, SCM system component or database. The data necessary for further servicing the screen is then passed to the central BAdI management. The interface implementation identification information including the screen identifier and data source identifier are passed on to the central BAdI management (block 413).

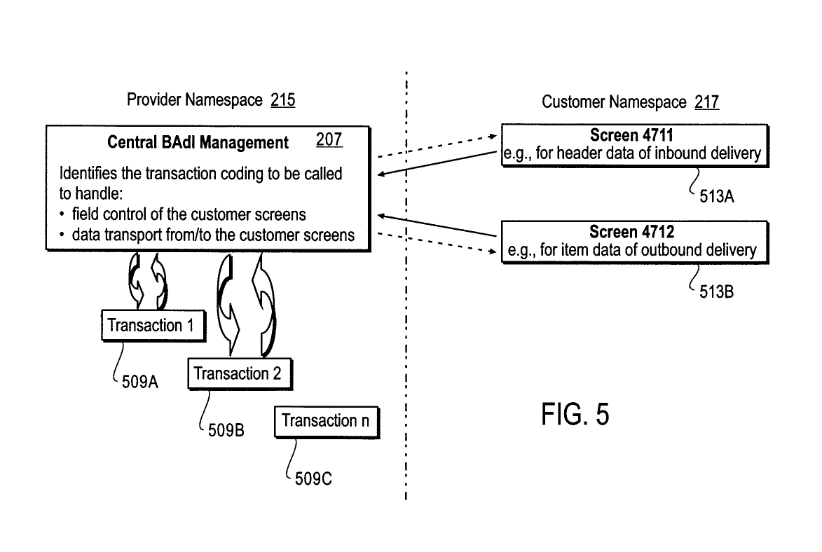

FIG. 5 is a diagram of one embodiment of a centralized enhancement transaction interaction. This diagram illustrates the interaction between the enhanced screens 113A, B, central BAdI management 207 and transactions 509A-C during operation of the SCM system. In response to a user interaction with screen 513A, e.g., a request to update viewed information or modify data in the screen 513A, the screen 513A invokes a method of the central BAdI management 207. The methods available to be invoked include the PBO and PAI methods. An example definition of the central BAdI class for servicing screen request is presented in TABLE II. The data passed as parameters to the central BAdI can include an identifier for the type of call, transaction identifier and enhancement identifier.

TABLE II
Service class: CL-Service
Management classes

| METHOD: | | |
|---|---|---|
| EXECUTE_SCREEN_LOGIC | | |
| Parameter | Type | Description |
| I_ORIGIN | CHAR1 | Identifier: call during |
| | | PBO/PAI |
| I_TRANSACTION | CHAR3 | Identifier for transactions |
| I_ENHANCEMENT | CHAR3 | Identifier for enhancement |

The central BAdI management 207 determines the appropriate transactions 509A-C to service the call from the screen 513A, B. An example transaction interface definition detailing a method that the central BAdI management 207 can call to service the screen request is set forth in TABLE III.

TABLE III
TA IF definition: IF_EXAMPLE_SAP
Interface implemented by SAP for participating transactions

| METHOD: | | |
|---|---|---|
| TRANSFER_SCREEN_DATA | | |
| Parameter | Type | Description |
| I_ORIGIN | CHAR1 | Identifier: call during |
| | | PBO/PAI |
| I_TRANSACTION | CHAR3 | Identifier for transactions |
| I_ENHANCEMENT | CHAR3 | Identifier for enhancement |
| I_DATA | ANY | Data to be transferred from |
| | | the application to the |
| | | customer screen |
| E_DATA | ANY | Data to be transferred from |
| | | the customer screen to the |
| | | application |

The transaction retrieves or updates data and any other program associated with the enhancement similarly processes the request in response to the central BAdI management. The central BAdI management receives the response from the transactions 509A-C and any enhancement related data source and forwards the response data to the screen and updates the screen to reflect the response data.

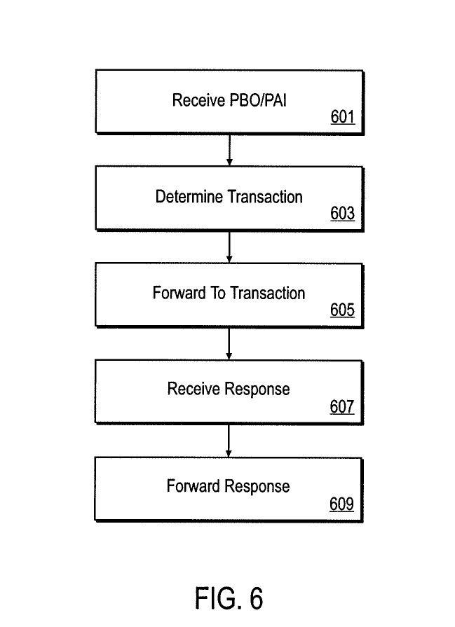

FIG. 6 is a flowchart of one embodiment of a process for transaction interaction processing. The illustrated process details servicing screens by transactions including enhancements based on the components described above in regard to claim 5. The process begins with the invocation of a method of the central BAdI management by the screen requiring servicing (block 601). In one embodiment, the method may be a PBO or PAI method. In another embodiment, a generic method is invoked designating the invocation as a PBO or PAI through a parameter of the generic method.

The central BAdI management executes the invoked method, which determines the transaction and/or associated enhancement programs to service the method. The communication between the interface implementation and the central BAdI management relies on the constants provided in the interface definition. This ensures clear visibility of the interface implementations available to the SCM system. The possible fields which the customer can use are defined by the provider. The structure can be the same for all transactions and/or enhancement types or specific structures can be defined for transactions and/or enhancements. Each transaction identifier is linked to a structure and a transaction. The structure is used to identify the corresponding transaction. Once the transaction is identified then the data from the method invocation of the central BAdI implementation is passed to the transaction (block 605).

The transaction processes the data and returns data to the central BAdI management (block 607). The central BAdI management then forwards the response to the screen that invoked the method and the screen is updated according to the action taken by the user (block 609). The screen is updated with new or calculated data and/or data is modified in the associated storage based on the type of method invoked by screen and the user of the screen.

In one embodiment, the components of the centralized enhancement service may be implemented as hardware devices. In another embodiment, these components may be implemented in software (e.g., microcode, assembly language or higher level languages). These software implementations may be stored on a machine-readable medium. A “machine readable” medium may include any medium that can store or transfer information. Examples of a machine readable medium include a ROM, a floppy diskette, a CD-ROM, a DVD, flash memory, hard drive, an optical disk or similar medium.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
receiving a request to service a customer defined screen enhancement;
determining a program to service the request; and
returning a value generated by the program to update the screen enhancement.

2. The method of claim 1, further comprising:
receiving a screen identifier with a request.

3. The method of claim 1, wherein the request includes a parameter specifying a process after input method or a process before output method.

4. The method of claim 3, further comprising:
calling the program; and
receiving the value from the program.

5. The method of claim 1, wherein the program is a transaction.

6. The method of claim 1, wherein the request is generated by an implementation of a centralized enhancement interface.

7. A machine readable medium having a set of instructions stored therein, which when executed, causes a machine to perform a set of operations comprising:
receiving a selection of a transaction;
checking for an enhancement implementation for the transaction; and
generating a screen with an enhancement populated using the enhancement implementation.

8. The machine readable medium of claim 7, having a further set of instructions stored therein, which when executed, cause a machine to perform a set of operations, further comprising:
sending transaction identification data to the enhancement implementation.

9. The machine readable medium of claim 7, having a further set of instructions stored therein, which when executed, cause a machine to perform a set of operations, further comprising:
receiving enhancement identification information from the enhancement implementation.

10. The machine readable medium of claim 8, having a further set of instructions stored therein, which when executed, cause a machine to perform a set of operations, further comprising:
passing enhancement management data to a central manager.

11. The machine readable medium of claim 7, having a further set of instructions stored therein, which when executed, cause a machine to perform a set of operations, further comprising:
searching a customer namespace for the enhancement implementation.

12. The machine readable medium of claim 7, having a further set of instructions stored therein, which when executed, cause a machine to perform a set of operations, further comprising:
retrieving a customer screen definition.

13. A system comprising:
a central enhancement module defining an interface for transaction management of a customer screen enhancement; and
a central management module to process a general request for the customer screen enhancement, the central management module to identify a transaction to handle the general request.

14. The system of claim 13, wherein the transaction handles data retrieval for the customer screen enhancement.

15. The system of claim 14, wherein the transaction handles data storage of user defined screens.

16. The system of claim 13, further comprising:
a user interface module to display and interact with customer screen enhancements.

17. The system of claim 13, further comprising:
a screen definition.

18. The system of claim 13, further comprising:
a plurality of transactions.

19. The system of claim 18, further comprising:
a plurality of interface implementations of an interface defined by the central enhancement module.

20. The system of claim 13, wherein the general request is one of a request to fill screen data or a request to store screen data.
